(19) United States
(12) Patent Application Publication
(10) Pub. No.: US 2019/0228743 A1
(43) Pub. Date: Jul. 25, 2019

(54) VIDEO DISPLAY DEVICE, METHOD FOR CONTROLLING VIDEO DISPLAY DEVICE, AND COMPUTER READBLE RECORDING MEDIUM

(71) Applicant: SHARP KABUSHIKI KAISHA, Sakai City, Osaka (JP)

(72) Inventor: YOSHIMITSU MURAHASHI, Sakai City (JP)

(21) Appl. No.: 16/306,675

(22) PCT Filed: Apr. 21, 2017
(86) PCT No.: PCT/JP2017/016066

§ 371 Date: Dec. 3, 2018

(30) Foreign Application Priority Data
Jun. 8, 2016 (JP) 2016-114833

(51) Int. Cl. G09G 5/36; H04N 5/66; G06F 3/14

(52) U.S. Cl. CPC G09G 5/363; G06F 3/14; H04N 5/66

(57) ABSTRACT

A less-distorted output video is displayed regardless of a viewpoint position of a user. A rendering unit (20) increases the number of pixels of an input video and generates an output video obtained by enlarging the input video. The rendering unit (20) continuously changes an enlargement ratio of the output video with respect to the input video on a display unit (30) so that an amount of an increase in the number of pixels of the output video with respect to the input video is increased as a position on the display unit (30) is farther from a reference position.

### TECHNICAL FIELD

The following disclosure relates to a video display device, a method for controlling the video display device, and a control program for the video display device, and relates to, for example, a video display device that performs rendering processing for an input video to the video display device.

### BACKGROUND ART

Video display devices are devices that display an output video on a display. Some of the video display devices perform rendering processing for an original video before being displayed. For example, a television receiving device (video display device) described in PTL 1 performs rendering processing for an original video by using a geometry engine and thereby tilts or rotates an output video on a display.

### CITATION LIST

### Patent Literature

PTL 1: Japanese Unexamined Patent Application Publication No. 2006-41979 (published on Feb. 9, 2006)

### SUMMARY OF INVENTION

### Technical Problem

Some video display devices change resolution of an original video before being displayed. For example, a video display device converts an original video, which is generated by the HD standard, into an output video that has resolution of the super high vision standard. In this case, a user may view the output video displayed on a display by coming closer to the display than a recommended viewing distance (3.0 H) of the original video that has resolution of the high vision standard.

In a case where a viewpoint position of the user, that is, a position on a display surface, which is gazed by the user, is close to a center of the display surface of the display, an angle formed by a sight line of the user seeing a corner of the display and the display surface of the display is small. Thus, due to a so-called perspective principle, the output video at the corner of the display appears to be distorted to the user.

With reference to FIGS. 7(a) and 7(b), description will be given for how an output video appears to the user in a case where the user comes closer to a display than a recommended viewing distance of an original video. FIGS. 7(a) and 7(b) are views for explaining how an output video appears to be distorted in a case where the user comes close to the display in a conventional video display device. FIG. 7(a) illustrates an output video seen by the user at the recommended viewing distance of the original video. FIG. 7(b) illustrates how a circular image at a lower right corner of the output video illustrated in FIG. 7(a) appears to the user in a case where the user comes closer to the display than the recommended viewing distance of the original video. As found from comparison between the circular image in the output video of FIG. 7(a) and the corresponding image of FIG. 7(b), in a case where the user comes closer to the display than the recommended viewing distance of the original video, the output video appears to be distorted to the user. In FIG. 7(b), actually, an image in the output video is contracted in a direction of an arrow compared to the circular image in the original video.

An aspect of the disclosure is made in view of the aforementioned problems and an object thereof is to display a less-distorted output video regardless of a viewpoint position of a user.

### Solution to Problem

In order to solve the aforementioned problems, a video display device according to an aspect of the disclosure includes: a video enlargement unit that increases the number of pixels of an input video input to the video display device and generates an output video obtained by enlarging the input video; and a display unit that displays the output video generated by the video enlargement unit, in which the video enlargement unit reduces, at a position close to a reference position on the display unit, an enlargement ratio of the output video with respect to the input video, and increases, at a position away from the reference position, the enlargement ratio of the output video with respect to the input video to thereby continuously change the enlargement ratio of the output video with respect to the input video on the display unit.

In order to solve the aforementioned problems, a method for controlling a video display device according to an aspect of the disclosure includes: a video enlargement step of increasing the number of pixels of an input video input to the video display device and generating an output video obtained by enlarging the input video; and a display step of displaying the output video generated at the video enlargement step on a display unit, in which in the video enlargement step, at a position close to a reference position on the display unit, an enlargement ratio of the output video with respect to the input video is reduced and at a position away from the reference position, the enlargement ratio of the output video with respect to the input video is increased to thereby continuously change the enlargement ratio of the output video with respect to the input video on the display unit.

### Advantageous Effects of Invention

According to an aspect of the disclosure, it is possible to display a less-distorted output video regardless of a viewpoint position of a user.

### BRIEF DESCRIPTION OF DRAWINGS

FIG. 1 is a block diagram illustrating a configuration of a video display device according to Embodiment 1.

FIG. 2 is a flowchart illustrating a flow of rendering processing according to Embodiment 1.

FIG. 3 illustrates a correspondence relationship between a reference pixel position in an output video and a corresponding position in an input video in Embodiment 1.

FIG. 4(a) illustrates an example of an output video displayed on a display unit of the video display device according to Embodiment 1, and FIG. 4(b) illustrates how a circular image at a lower right corner in the output video appears in a case where a user sees the lower right corner of the output video from a viewpoint position illustrated in FIG. 4(a).

FIG. 5 illustrates an example of a correspondence relationship between an input video signal and an output video signal.

FIG. 6 illustrates a correspondence relationship between a reference pixel position in an output video and a corresponding position in an input video in Embodiment 2.

FIGS. 7(a) and 7(b) are views for explaining how an output video appears to be distorted in a case where a user comes close to a display in a conventional video display device.

### DESCRIPTION OF EMBODIMENTS

### Embodiment 1

Embodiment 1 of the disclosure will be described in detail below.

### (Video Display Device 1)

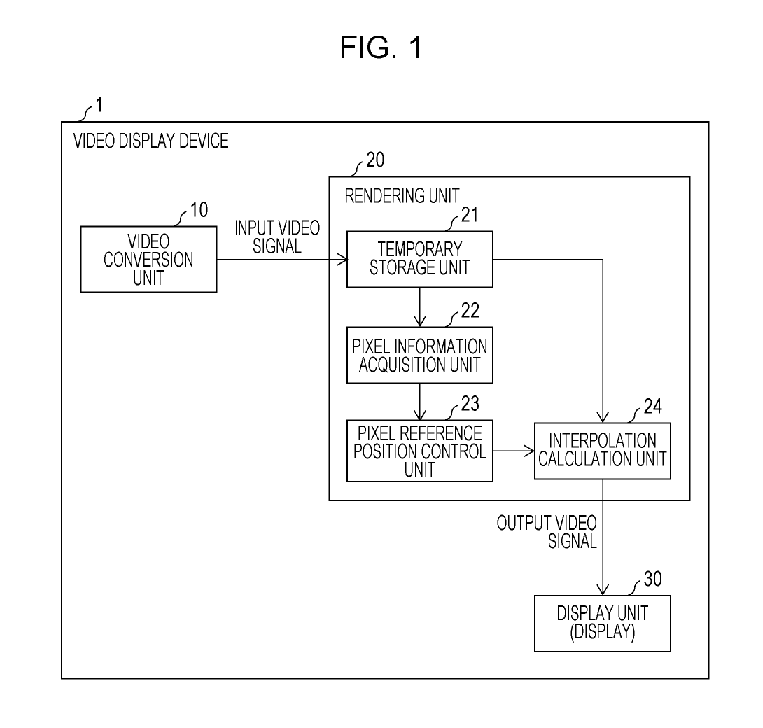

A configuration of a video display device 1 will be described with reference to FIG. 1. FIG. 1 is a block diagram illustrating the configuration of the video display device 1. As illustrated in FIG. 1, the video display device 1 includes a video conversion unit 10, a rendering unit 20 (video enlargement unit), and a display unit 30. The video display device 1 may be, for example, a television receiver, a projector, or a personal computer. The display unit 30 may be, for example, a liquid crystal display or a screen.

The video conversion unit 10 acquires original video data from an HDD (Hard Disc Drive) recorder, a media reproducing device, the Internet, or the like. Here, the HDD recorder and the media reproducing device may be included in the video display device 1 or connected to the video display device 1. The video conversion unit 10 converts resolution of the acquired original video data into a format that allows processing by the rendering unit 20. The video conversion unit 10 outputs an input video signal that includes the generated input video data to the rendering unit 20.

The rendering unit 20 executes rendering processing (described below) for the input video data output from the video conversion unit 10 and generates output video data. Then, the rendering unit 20 outputs the generated output video data to the display unit 30. The rendering unit 20 includes a temporary storage unit 21, a pixel information acquisition unit 22, a pixel reference position control unit 23 (pixel data extraction unit), and an interpolation calculation unit 24 (pixel data interpolation unit). An operation of each of the units of the rendering unit 20 will be described in description for the rendering processing.

### (Flow of Rendering Processing)

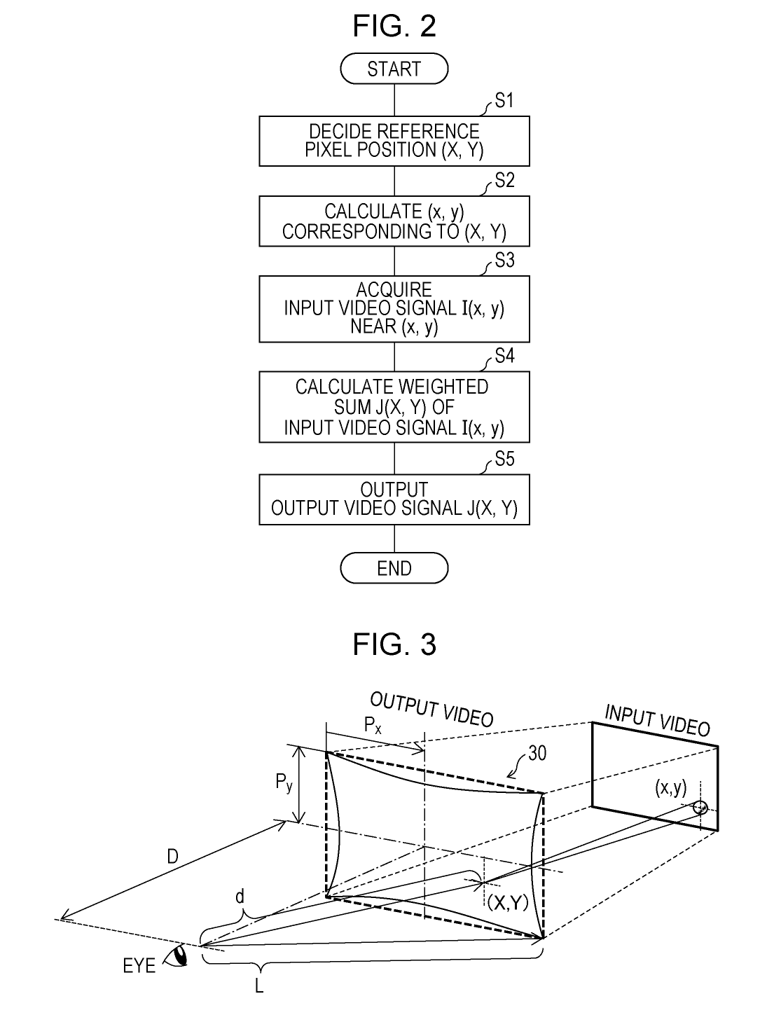

With reference to FIGS. 2 and 3, a flow of the rendering processing executed by the rendering unit 20 will be described. FIG. 2 is a flowchart illustrating a flow of the rendering processing. FIG. 3 illustrates correspondence between a reference pixel position (X, Y) and a corresponding position (x, y) and illustrates a positional relationship between a reference position (Px, Py) and the reference pixel position (X, Y). In the temporary storage unit 21, input video data output by the video conversion unit 10 is stored.

As illustrated in FIG. 2, in the rendering processing, first, the pixel information acquisition unit 22 decides the reference pixel position (X, Y) in an output video, that is, a position at which a reference pixel is interpolated to the output video (S1).

The pixel reference position control unit 23 decides the corresponding position (x, y) in an input video, which corresponds to (X, Y) (S3). For example, the pixel reference position control unit 23 may calculate the corresponding position (x, y) that corresponds to the reference pixel position (X, Y) in accordance with the following formula.

x=a(X−Pₓ)+Pₓ

y=a(Y−P_{y})+P_{y} [Mathematical formula 1]

As illustrated in FIG. 3, the reference position (Px, Py) in the formula may be, for example, a viewpoint position of a user, at which an eye position of the user is projected on the display unit 30 (at a shortest distance). In the present embodiment, (Px, Py) is a center of the output video when being displayed on the display unit 30. Moreover, an inverse of a parameter a indicates an enlargement ratio of the output video with respect to the input video. That is, on the basis of the enlargement ratio, the pixel reference position control unit 23 selects one or more pixels of the input video that correspond to a reference pixel to be interpolated to the output video.

The video display device 1 may require the user to input, as the reference position (Px, Py), the viewpoint position when viewing the output video or may automatically detect the viewpoint position of the user by using an infrared sensor (not illustrated) included in the display unit 30. Alternatively, through a setting menu of the video display device 1, the user may be allowed to perform an input indicating to what extent the position of the user is deviated in a vertical or horizontal direction from the center of the output video.

The parameter a is a function of the reference pixel position (X, Y) in the output video. The parameter a is preferably reduced as the reference pixel position (X, Y) is farther from the center (Px, Py) of the output video. In this case, as (X, Y) is away from (Px, Py), the parameter a is reduced (that is, the enlargement ratio is increased), so that a change amount of (X, Y) with respect to a change of (x, y) is increased. In other words, as (X, Y) is closer to a corner of the display unit 30, the enlargement ratio of the output video with respect to the input video is increased. To the contrary, as (X, Y) is closer to the center (Px, Py) of the output video, the parameter a is increased, so that the enlargement ratio of the output video with respect to the input video is reduced.

The interpolation calculation unit 24 acquires an input video signal I(x, y) corresponding to a pixel at (x, y) and a pixel proximate thereto from the temporary storage unit 21. Then, in accordance with a formula described below, the interpolation calculation unit 24 calculates an output video signal J(X, Y) corresponding to a pixel proximate to the reference pixel position (X, Y) from the input video signal I(x, y) corresponding to the pixel proximate to the corresponding position (x, y) (S4). Note that, an example of algorithm of the calculation at S4 will be described below. The interpolation calculation unit 24 outputs the output video signal J(X, Y) to the display unit 30 (S5). Note that, S1 to S5 described above correspond to a video enlargement step of the disclosure.

The display unit 30 displays, at the reference pixel position (X, Y) on the display unit 30, an output video according to the output video signal J(X, Y) (display step).

(Correspondence between S(X, Y) and (x, y))

With reference to FIG. 3, details of algorithm for the pixel reference position control unit 23 to calculate the corresponding position (x, y) in the input video from the reference pixel position (X, Y) in the output video at S2 of the rendering processing described above will be described. Parameters d and L illustrated in FIG. 3 are calculated by the following formula.

d=\sqrt{(X−Pₓ)²+(Y−P_{y})+(D)²}

L=\sqrt{Pₓ²+P_{y}²+(D)²} [Mathematical formula 2]

In the formula, a variable D indicating a distance between the eye position of the user and the display unit 30, that is, a viewing distance of the user may be set in accordance with image quality of the output video. For example, in a case where the image quality of the output video is equivalent to that of a video of the SHD standard, D may be set to a recommended viewing distance of the video of the SHD standard, 0.75 H (H is a height of the display unit 30). Alternatively, the user may be allowed to input D from the setting menu of the video display device 1 or the viewing distance of the user may be detected by using the infrared sensor or the like of the display unit 30.

The parameter a described above may be calculated in accordance with the following formula.

$$a = \frac{1 / d}{1 / L} = \frac{L}{d} = \frac{\sqrt{{P}_{x}^{2} + {P}_{y}^{2} + {( D )}^{2}}}{\sqrt{{( X - {P}_{x} )}^{2} + {( Y - {P}_{y} )}^{2} + {( D )}^{2}}} \qquad [ Mathematical formula 3 ]$$

As found from the formula, as the reference pixel position (X, Y) is farther from the center (Px, Py) of the output video, that is, as the reference pixel position (X, Y) is closer to the corner of the display unit 30, the enlargement ratio of the output video with respect to the input video data is increased. That is, at the corner of the display unit 30, the original video is greatly stretched. Moreover, the enlargement ratio (that is, inverse of the parameter a) depends on the distance d or D between the eye position of the user and the display unit 30 (refer to FIG. 3).

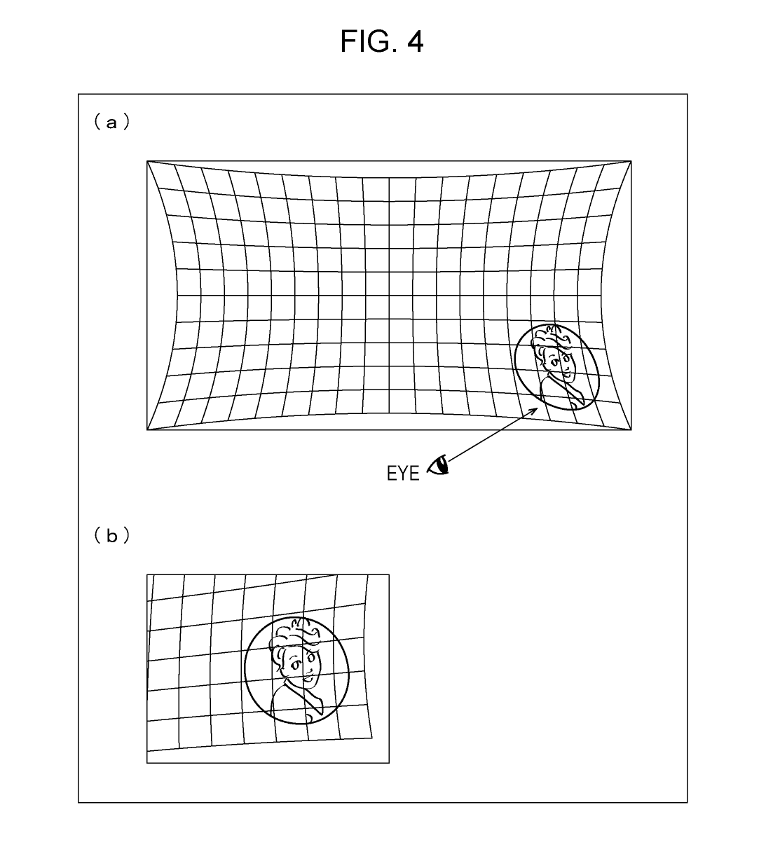

FIG. 4(a) illustrates an example of an output video displayed on the display unit 30. As illustrated in FIG. 4(a), in a case where the viewing distance D of the user is close to 0 and the viewpoint position (Px, Py) of the user is close to the center of the output video, a direction of a sight line of the user who sees the corner of the display unit 30 is substantially parallel to the display surface of the display unit 30.

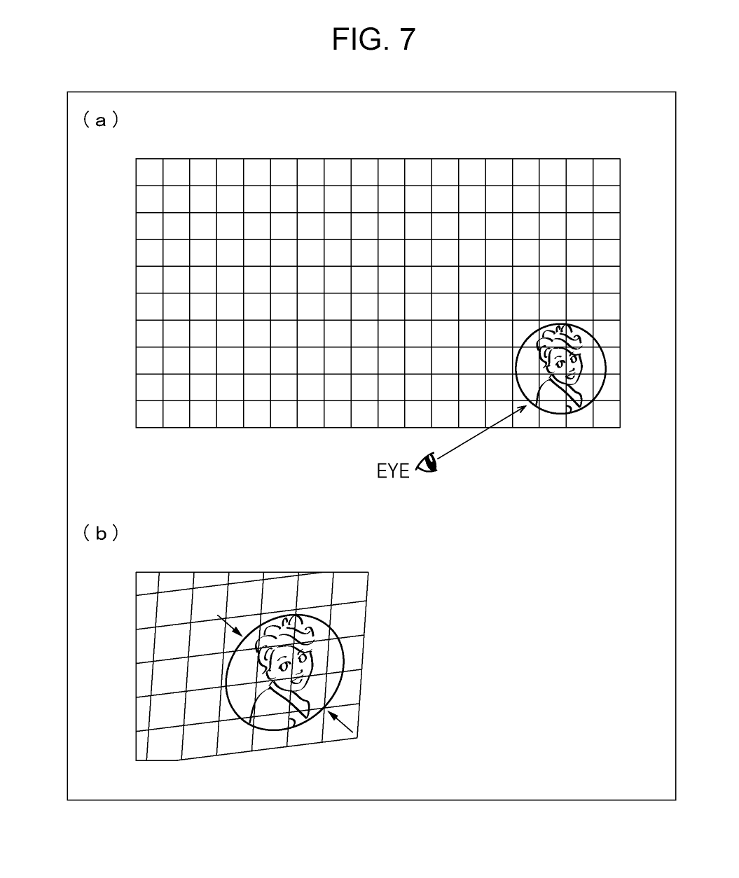

FIG. 4(b) illustrates how a circular image at a lower right corner in the output video illustrated in FIG. 4(a) appears in a case where the user sees the lower right corner of the output video from the position illustrated in FIG. 4(a). At the corner of the display unit 30, the output video is stretched by the rendering unit 20. Moreover, due to a perspective effect, an image at the lower right corner in the output video appears to be contracted to the user. The stretch and the contraction of the output video cancel out each other. As a result, the user is able to see a less-distorted output video, that is, an output video close to an original video at the corner of the display unit 30. Actually, when FIG. 4(b) and FIG. 7(b) are compared, it is found that distortion (FIG. 4(b)) of the output video in a configuration of the present embodiment is less than distortion (FIG. 7(b)) of an output video in a conventional configuration.

### (S4: Input Video Signal and Output Video Signal)

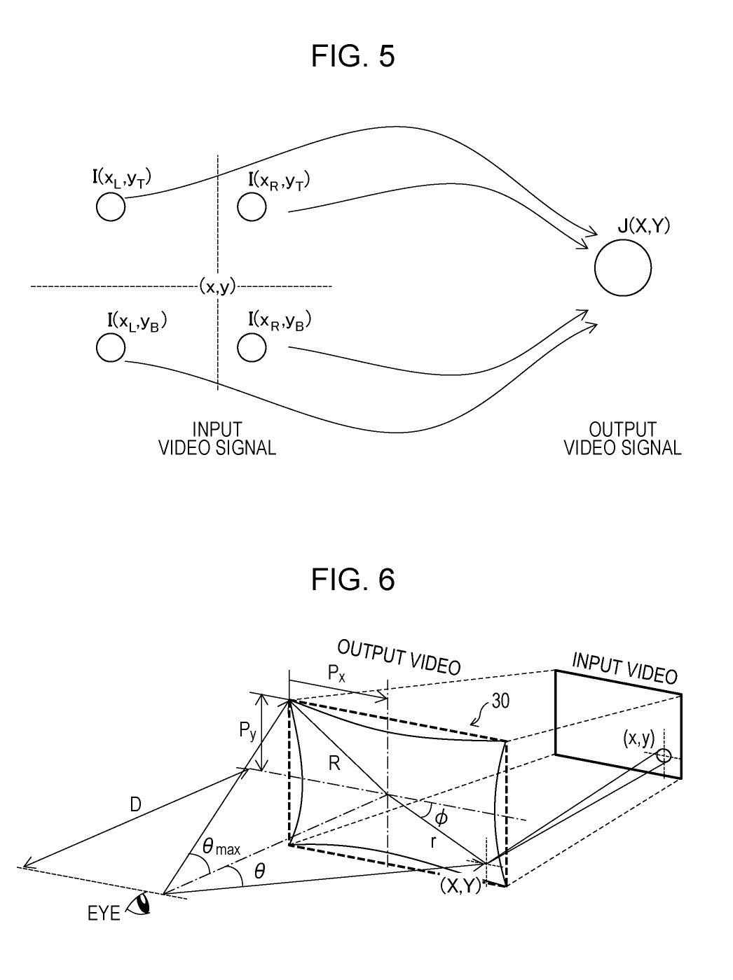

With reference to FIG. 5, details of algorithm for the interpolation calculation unit 24 to generate the output video signal J(X, Y) from the input video signal I(x, y) at S4 of the rendering processing described above will be described. FIG. 5 illustrates an example of a correspondence relationship between the input video signal I(x, y) and the output video signal J(X, Y).

As illustrated in FIG. 5, the input video signal I(x, y) may be constituted by a plurality of input video signals I(x_{L}, y_{T}), I(x_{R}, y_{T}), I(x_{L}, y_{B}), and I(x_{R}, y_{B}). Here, (x_{L}, y_{T}) (x_{R}, y_{T}), (x_{L}, y_{B}), and (x_{R}, y_{B}) are coordinates of pixels proximate to the corresponding position (x, y) in the input video. The input video signal I(x, y) may be constituted by an input video signal corresponding to one or more pixels.

The output video signal J(X, Y) may be calculated from the input video signals I(x_{L}, y_{T}), I(x_{R}, y_{T}), I(x_{L}, y_{B}), and I(x_{R}, y_{B}), for example, in accordance with the following formula.

x_{L}=└x┘,y_{T}=└y┘

x_{R}=└x┘+1,y_{B}=└y┘+1

w_{xL}=x_{R}−x,w_{yT}=y_{B}−y

w_{xR}=x−x_{R},w_{yB}=y−y_{T}

J(X,Y)=w_{xL}w_{yT}I(x_{L},y_{T})+w_{xR}w_{yT}I(x_{R},y_{T})+w_{xL}w_{yB}I(x_{L},y_{B})+w_{xR}w_{yB}I(x_{R},y_{B}) [Mathematical formula 4]

Here, w_{xL}, w_{xR}, w_{yT}, and w_{yB} respectively indicate weights of the input video signals I(x_{L}, y_{T}), I(x_{R}, y_{T}), I(x_{L}, y_{B}), and I(x_{R}, y_{B}). In the formula, a greater weight is assigned to an input video signal corresponding to a pixel closer to the corresponding position (x, y).

### Embodiment 2

Embodiment 2 of the disclosure will be described as follows. Note that, for convenience of description, a member having the same function as that of the member described in the foregoing embodiment will be given the same reference sign and description thereof will be omitted.

In the present embodiment, a method for calculating the parameter a described in Embodiment 1 above by algorithm different from that of Embodiment 1 above will be described.

### (S2: Correspondence Between (X, Y) and (x, y))

FIG. 6 illustrates a correspondence relationship between the reference pixel position (X, Y) in the output video and the corresponding position (x, y) in the input video. Parameters φ, R, θ, θₘₐₓ, and r that are illustrated in FIG. 6 indicate a relationship between the viewpoint position (Pₓ, P_{y}) of the user and the reference pixel position (X, Y) in the output video. The respective parameters φ, R, θ, θₘₐₓ, and r are calculated by the following formula.

$$φ = a tan ( \frac{Y - {P}_{y}}{X - {P}_{x}} ) = a tan 2 ( Y - {P}_{y} , X - {P}_{x} ) \\ R = \sqrt{{P}_{x}^{2} + {P}_{y}^{2}} \\ {θ}_{max} = a tan ( \frac{R}{D} ) = a tan 2 ( R , D ) \\ r = \sqrt{{( X - {P}_{x} )}^{2} + {( Y - {P}_{y} )}^{2}} \\ θ = a tan ( \frac{r}{D} ) = a tan 2 ( r , D ) \qquad [ Mathematical formula 5 ]$$

In the formula, R is a distance between the viewpoint position (Px, Py) of the user and the corner (0, 0) of the display unit 30 and r indicates a distance between the viewpoint position (Px, Py) of the user and the reference pixel position (X, Y) in the output video. Moreover, θ is an angle formed by a sight line of the user directed to the center (Px, Py) of the output video and the reference pixel position (X, Y) and θₘₐₓ is a maximum value of θ. Moreover, φ is an angle formed by a vector (X−Px, Y−Py) and an x-axis. Note that, a tan 2 is a function to calculate a tan (inverse function of tan) in a programming language such as the C language. When a tan is represented by a format of a tan 2, the aforementioned formula is obtained.

In the present embodiment, the parameter a is calculated by the following formula.

$$cos ( θ ) = \frac{D}{\sqrt{{( X - {P}_{x} )}^{2} + {( Y - {P}_{y} )}^{2} + {D}^{2}}} \\ cos ( {θ}_{max} ) = \frac{D}{\sqrt{{P}_{x}^{2} + {P}_{y}^{2} + {D}^{2}}} \\ a = cos ( θ ) / cos ( {θ}_{max} ) \qquad [ Mathematical formula 6 ]$$

The parameter a calculated by the algorithm described in the present embodiment is substantially equal to the parameter a described in Embodiment 1 above. However, in the present embodiment, the parameter a is represented by each calculation of addition and subtraction, multiplication, a square-root of sum of squares, cos, and a tan. Both the addition and subtraction and the multiplication are calculation with a low load. The calculation of a tan and the calculation of the square-root of sum of squares are able to be relatively easily executed by using existing algorithm. The algorithm to calculate the parameter a described in the present embodiment is able to be achieved by a relatively small electronic circuit.

### Embodiment 3

Embodiment 3 of the disclosure will be described as follows. Note that, for convenience of description, a member having the same function as that of the member described in the foregoing embodiment will be given the same reference sign and description thereof will be omitted.

The enlargement ratio between the reference pixel position (X, Y) in the output video and the corresponding position (x, y) in the input video is not limited to the parameter a described in Embodiments 1 and 2 above as long as satisfying a condition that the enlargement ratio continuously changes with a change of (X, Y).

In the present embodiment, (X, Y) and (x, y) are associated with each other in accordance with the following formula.

$$x = R \frac{θ}{{θ}_{max}} cos φ + {P}_{x \\} \\ y = R \frac{θ}{{θ}_{max}} sin φ + {P}_{y \\} \qquad [ Mathematical formula 7 ]$$

The parameters φ and θ are the same as those described in Embodiment 2 above (refer to FIG. 6). The enlargement ratio of the present embodiment is represented by φ and θ. As found from FIG. 6, as (X, Y) is closer to coordinates of the corner of the display unit 30, θ and φ are increased and the enlargement ratio is also increased.

A change rate of θ is represented by the following formula.

$$\frac{\partial }{\partial r} a tan ( \frac{r}{D} ) = \frac{1}{D } \frac{1}{1 + {( r / D )}^{2}} = \frac{D}{{D}^{2} + {r}^{2}} \qquad [ Mathematical formula 8 ]$$

According to the formula, when r is equal to 0, the change ratio of θ is largest, and when r is equal to R, the change ratio of θ is smallest. This indicates that a degree of stretching of the output video is smallest at the center (Px, Py) of the output video, and as (X, Y) is closer to the corner of the display unit 30, the degree of the stretching of the output video is increased.

The parameters φ and θ in the present embodiment are also described only by a trigonometric function, an inverse trigonometric function, and a square-root of sum of squares, similarly to the parameter a of Embodiment 2 above. Thus, by using existing algorithm, the enlargement ratio is able to be calculated through calculation processing with a relatively small load. The algorithm to calculate the enlargement ratio described in the present embodiment is able to be achieved by a relatively small electronic circuit.

### [Example of Realization by Software]

A control block (in particular, the video conversion unit 10 and the rendering unit 20) of the video display device 1 may be realized by a logic circuit (hardware) provided in an integrated circuit (IC chip) or the like or may be realized by software with use of a CPU (Central Processing Unit).

In the latter case, the video display device 1 includes a CPU that executes a command of a program that is software enabling each of functions, a ROM (Read Only Memory) or a storage device (each referred to as a “recording medium”) in which the program and various kinds of data are stored so as to be readable by a computer (or a CPU), a RAM (Random Access Memory) that develops the program, and the like. An object of the disclosure is achieved by a computer (or a CPU) reading and executing the program from the recording medium. As the recording medium, for example, a “non-transitory tangible medium” such as a tape, a disk, a card, a semiconductor memory, or a programmable logic circuit may be used. The program may be supplied to the computer via any transmission medium (such as a communication network or a broadcast wave) which enables the program to be transmitted. Note that, the disclosure can also be achieved in a form of a data signal in which the program is embodied through electronic transmission and which is embedded in a carrier wave.

### Conclusion

A video display device (1) according to an aspect 1 of the disclosure includes: a video enlargement unit (rendering unit 20) that increases the number of pixels of an input video input to the video display device and generates an output video obtained by enlarging the input video; and a display unit (30) that displays the output video generated by the video enlargement unit, in which the video enlargement unit reduces, at a position close to a reference position on the display unit, an enlargement ratio of the output video with respect to the input video, and increases, at a position away from the reference position, the enlargement ratio of the output video with respect to the input video to thereby continuously change the enlargement ratio of the output video with respect to the input video on the display unit.

According to the aforementioned configuration, the enlargement ratio of the output video with respect to the input video continuously changes on the display unit. The change cancels out a perspective effect caused when the display unit is seen from the reference position. Thus, in a case where a user sees the output video from a vicinity of the reference position or a case where the reference position is set so as to correspond to a viewpoint position of the user, a less-distorted output video is able to be displayed.

In the video display device according to an aspect 2 of the disclosure, in the aspect 1, the video enlargement unit may include: (a) a temporary storage unit (21) that stores data of the input video; (b) a pixel data extraction unit (pixel reference position control unit 23) that extracts, out of the data of the input video stored in the temporary storage unit, data of a pixel of the input video corresponding to a pixel interpolated to the output video; and (c) a pixel data interpolation unit (interpolation calculation unit 24) that generates data of the pixel, which is interpolated to the output video, on a basis of the data of the pixel of the input video extracted by the pixel data extraction unit, in which the pixel data extraction unit may select, on a basis of the enlargement ratio, one or more pixels of the input video corresponding to the pixel interpolated to the output video.

According to the aforementioned configuration, the data of the pixel interpolated to the output video is able to be generated on the basis of the data of the pixel of the input video.

In the video display device according to an aspect 3 of the disclosure, in the aspect 1 or 2, the reference position may be a position at which an eye position of a user is projected onto the display unit.

In the video display device according to an aspect 4 of the disclosure, in any of the aspects 1 to 3, the enlargement ratio may be calculated on a basis of a distance between the eye position of the user and the display unit.

According to the aforementioned configuration, the enlargement ratio is able to be increased as a position on the display unit is farther from the eye position of the user.

A method for controlling a video display device according to an aspect 5 of the disclosure includes: a video enlargement step of increasing the number of pixels of an input video input to the video display device and generating an output video obtained by enlarging the input video; and a display step of displaying the output video generated at the video enlargement step on a display unit, in which in the video enlargement step, at a position close to a reference position on the display unit, an enlargement ratio of the output video with respect to the input video is reduced and at a position away from the reference position, the enlargement ratio of the output video with respect to the input video is increased to thereby continuously change the enlargement ratio of the output video with respect to the input video on the display unit.

According to the aforementioned configuration, an effect similar to that of the video display device according to the aspect 1 is able to be exerted.

The video display device according to each aspect of the disclosure may be enabled by a computer, and in such case, a control program for the video display device that causes the video display device to be realized by a computer by causing the computer to operate as each unit (software element) of the video display device, and a computer-readable recording medium having the control program recorded therein are also included in the scope of the disclosure.

The disclosure is not limited to each of the embodiments described above, and may be modified in various manners within the scope indicated in the claims and an embodiment achieved by appropriately combining technical means disclosed in different embodiments is also encompassed in the technical scope of the disclosure. Further, by combining the technical means disclosed in each of the embodiments, a new technical feature may be formed.

### CROSS-REFERENCE OF RELATED APPLICATION

This application claims the benefit of priority to Japanese Patent Application No. 2016-114833 filed on Jun. 8, 2016, the content of which is incorporated herein by reference in its entirety.

### REFERENCE SIGNS LIST

1 video display device
20 rendering unit (video enlargement unit)
21 temporary storage unit
23 pixel reference position control unit (pixel data extraction unit)
24 interpolation calculation unit (pixel data interpolation unit)
30 display unit

1. A video display device comprising:
a video enlargement unit that increases the number of pixels of an input video input to the video display device and generates an output video obtained by enlarging the input video; and
a display unit that displays the output video generated by the video enlargement unit, wherein
the video enlargement unit reduces, at a position close to a reference position on the display unit, an enlargement ratio of the output video with respect to the input video, and increases, at a position away from the reference position, the enlargement ratio of the output video with respect to the input video to thereby continuously change the enlargement ratio of the output video with respect to the input video on the display unit.

2. The video display device according to claim 1, wherein
the video enlargement unit includes:
(a) a temporary storage unit that stores data of the input video;
(b) a pixel data extraction unit that extracts, out of the data of the input video stored in the temporary storage unit, data of a pixel of the input video corresponding to a pixel interpolated to the output video; and
(c) a pixel data interpolation unit that generates data of the pixel, which is interpolated to the output video, on a basis of the data of the pixel of the input video extracted by the pixel data extraction unit, wherein
the pixel data extraction unit selects, on a basis of the enlargement ratio, one or more pixels of the input video corresponding to the pixel interpolated to the output video.

3. The video display device according to claim 1, wherein the reference position is a position at which an eye position of a user is projected onto the display unit.

4. The video display device according to claim 1, wherein the enlargement ratio is calculated on a basis of a distance between an eye position of a user and the display unit.

5. A method for controlling a video display device, the method comprising:
a video enlargement step of increasing the number of pixels of an input video input to the video display device and generating an output video obtained by enlarging the input video; and
a display step of displaying the output video generated at the video enlargement step on a display unit, wherein
in the video enlargement step, at a position close to a reference position on the display unit, an enlargement ratio of the output video with respect to the input video is reduced and at a position away from the reference position, the enlargement ratio of the output video with respect to the input video is increased to thereby continuously change the enlargement ratio of the output video with respect to the input video on the display unit.

6. A computer readable recording medium in which a control program causing a computer to function as the video display device according to claim 1 and causing the computer to function as the video enlargement unit is recorded.

7. The video display device according to claim 2, wherein the reference position is a position at which an eye position of a user is projected onto the display unit.

8. The video display device according to claim 2, wherein the enlargement ratio is calculated on a basis of a distance between an eye position of a user and the display unit.

9. The video display device according to claim 3, wherein the enlargement ratio is calculated on a basis of a distance between the eye position of the user and the display unit.

10. The video display device according to claim 7, wherein the enlargement ratio is calculated on a basis of a distance between the eye position of the user and the display unit.
